(19) United States
(12) Patent Application Publication
(10) Pub. No.: US 2022/0095120 A1
(43) Pub. Date: Mar. 24, 2022

(54) USING MACHINE LEARNING TO DEVELOP CLIENT DEVICE TEST POINT IDENTIFY A NEW POSITION FOR AN ACCESS POINT (AP)

(71) Applicant: ARRIS Enterprises LLC, Suwanee, GA (US)

(72) Inventors: Krishna Prasad PANJE, Bengaluru (IN); Divyashree KANTHILA, Bengaluru (IN)

(21) Appl. No.: 17/463,949

(22) Filed: Sep. 1, 2021

Related U.S. Application Data
(60) Provisional application No. 63/081,030, filed on Sep. 21, 2020.

(51) Int. Cl. H04W 16/18; H04B 17/318; H04W 24/02

(52) U.S. Cl. CPC H04W 16/18; H04W 88/08; H04W 24/02; H04B 17/318

(57) ABSTRACT

A network device using machine learning to develop client device test points and identifying a new position for an access point (AP). As client device changes position within location, signal quality measurements, such as RSSI and dwell times for the client device, are collected at identified coordinates. The collected signal quality measurements and the coordinates of the client device are provided to the machine learning classifier. Test point data for the AP are generated by the machine learning classifier, and based on the test point data, coordinates for the modification of the position of the AP are generated. The coordinates for the modification of the position of the AP are provided to the client device so the user may move the AP to the new position.

### BACKGROUND

The subject matter of the present disclosure relates generally to using machine learning to process test point data from client devices to identify an improved new position for an access point (AP).

Typically, AP installations are performed once in a business or home. However, several users may use Wi-Fi services, such as VoWiFi (Voice over Wi-Fi), and exhibit different usage and hence different roaming patterns. As roaming patterns of the users change, the signal coverage provided by an AP to the client devices may change. The AP may provide better coverage if the AP is moved to another location.

### SUMMARY

Aspects of the present disclosure are drawn to using machine learning to process test point data from client devices to identify an improved new position for an access point (AP). Initial signal quality measurements and coordinates for a client device relative to an access point (AP) are determined. The initial signal quality measurements and the coordinates of the client device relative to the AP are provided to a machine learning classifier for initial training of the machine learning classifier. Signal quality measurements and coordinates of the client device relative to the AP are collected as the client device changes position within a location. The collected quality measurements and the coordinates of the client device relative to the AP are provided to the machine learning classifier. Test point data for the AP are generated using the machine learning classifier. Based on the test point data associated with the AP, a modification of the position of the AP is determined. The modification to the position of the AP is determined from the test point data.

In an aspect of the present disclosure, a network device generates test point data using coordinates of the client device relative to an AP, received signal strength indicators (RSSI) associated with each of the coordinates, and dwell times of the client device associated with each of the coordinates.

In an aspect of the present disclosure, a network device decides a modification of the position of the AP is required based on a mean RSSI for all test points is less than a signal quality threshold and a mean dwell time for all test points is greater than a dwell time threshold.

In an aspect of the present disclosure, a network device determines initial signal quality measurements and coordinates relative to the AP by monitoring compass and accelerometer values, performing periodic signal quality measurements, storing the signal quality measurements and the coordinates relative to the AP, identifying dead zone coordinates relative to the AP based on the signal quality measurements. and repeating the monitoring, performing, storing and identifying for additional APs at the location.

In an aspect of the present disclosure, a network device provides a notification to the client device indicating the client device is positioned in a dead zone.

In an aspect of the present disclosure, a network device collects signal quality measurements by measuring received signal strength indicators (RSSI).

In an aspect of the present disclosure, a network device provides the coordinates for the modification of the position of the AP to the client device.

### BRIEF SUMMARY OF THE DRAWINGS

The accompanying drawings, which are incorporated in and form a part of the specification, illustrate examples of the subject matter of the present disclosure and, together with the description, serve to explain the principles of the present disclosure. In the drawings:

FIG. 1 is a schematic diagram of a system.

FIG. 2 illustrates a wireless communication system.

FIG. 3 illustrates wireless communication devices positioned in a location.

FIG. 4 illustrates a block diagram of a network device.

FIGS. 5a-5b illustrate a flow chart for using machine learning to develop client device test point and identify a new position for an access point (AP).

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness.

Aspects of the present disclosure are directed to using machine learning to process test point data from client devices to identify an improved new position for an access point (AP). Users may exhibit different usage and hence different roaming patterns within a coverage area provided by an AP. As roaming patterns of the users change, the signal coverage provided by an AP to the client devices may change. The AP may provide better coverage if the AP is moved to another location. Test point data associated with the AP may be gathered from client devices as such client devices roam within the network. The test point data may be processed using machine learning to decide a modification of the position of the AP is required. Coordinates for a modified position of the AP may be determined and provided to a client device so that a user may move the AP to the modified position.

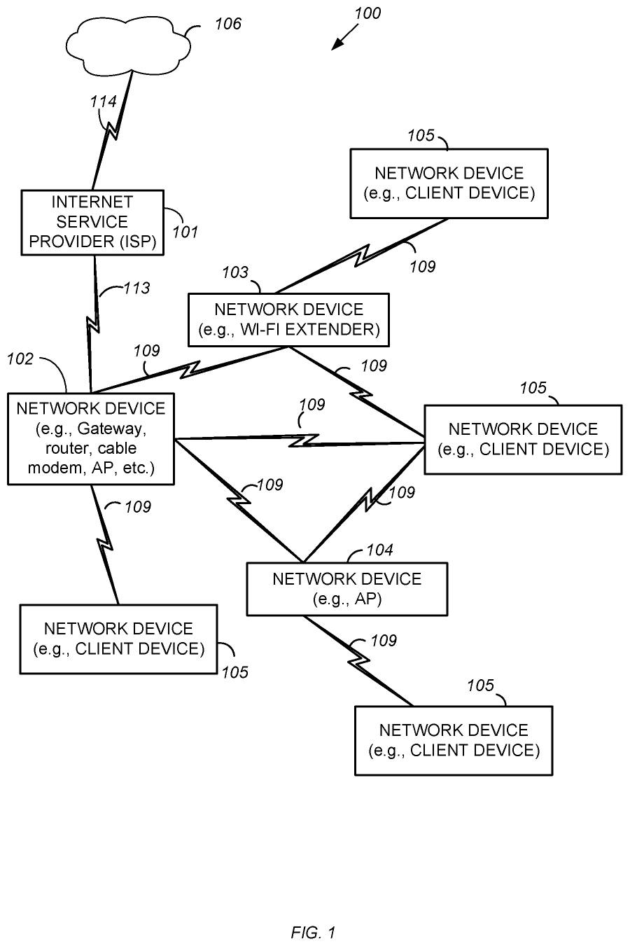

FIG. 1 is a schematic diagram of a system 100.

As shown in FIG. 1, the elements of the system include a network device 102 connected to the Internet 106 via an Internet Service Provider (ISP) 101 and also connected to different wireless devices such as wireless extenders 103, access point (AP) 104, and wireless client devices 105. The system shown in FIG. 1 includes wireless devices (e.g., wireless extender 103, AP 104, and wireless client devices 105) that may be connected in one or more wireless networks (e.g., private, guest, iControl, backhaul network, or Internet of things (IoT) network) within the system. Additionally, there could be some overlap between wireless devices (e.g., wireless extender 103, AP 104, and wireless client devices 105) in the different networks. That is, one or more network devices could be located in more than one network. For example, the wireless extenders 103 could be located both in a private network for providing content and information to wireless client devices 105 and also included in a backhaul network or an iControl network.

Starting from the top of FIG. 1, the ISP 101 can be, for example, a streaming video provider or any computer for connecting the network device 102 to the Internet 106. The connection 114 between the Internet 106 and the ISP 101 and the connection 113 between the ISP 101 and the network device 102 can be implemented using a wide area network (WAN), a virtual private network (VPN), metropolitan area networks (MANs), system area networks (SANs), a DOCSIS (Data Over Cable Service Interface Specification) network, a fiber optics network (e.g., FTTH (fiber to the home) or FTTX (fiber to the x), or hybrid fiber-coaxial (HFC)), a digital subscriber line (DSL), a public switched data network (PSDN), a global Telex network, or a 2G, 3G, 4G or 5G network, for example.

The connection 113 can further include as some portion thereof a broadband mobile phone network connection, an optical network connection, or other similar connections. For example, the connection 113 can also be implemented using a fixed wireless connection that operates in accordance with, but is not limited to, 3rd Generation Partnership Project (3GPP) Long Term Evolution (LTE) or 5G protocols. It is also contemplated by the present disclosure that connection 113 is capable of providing connections between the network device 102 and a WAN, a LAN, a VPN, MANs, personal area networks (PANs), wireless LANs (WLANs), SANs, a DOCSIS network, a fiber optics network (e.g., FTTH, FTTX, or HFC), a PSDN, a global Telex network, or a 2G, 3G, 4G or 5G network, for example.

The network device 102 can be, for example, a hardware electronic device that may be a combination modem and gateway device that combines the functions of a modem, an access point, and/or a router for providing content received from the content provider 101 to network devices (e.g., wireless extender 103, AP 104, and wireless client devices 105) in the system. It is also contemplated by the present disclosure that the network device 102 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content.

The connection 109 between the network device 102, the wireless extenders 103, and wireless client devices 105 can be implemented using a wireless connection in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the citizens broadband radio service (CBRS) band, 2.4 GHz bands, 5 GHz bands, 6 GHz bands, 60 GHz bands, etc. Additionally, the connection 109 can be implemented using a wireless connection that operates in accordance with, but is not limited to, Radio Frequency for Consumer Electronics (RF4CE) protocol, ZigBee protocol, Z-Wave protocol, or IEEE 802.15.4 protocol. It is also contemplated by the present disclosure that the connection 109 can include connections to a media over coax (MoCA) network. One or more of the connections 109 can also be a wired Ethernet connection.

The wireless extenders 103 can be, for example, hardware electronic devices used to extend the wireless network by receiving the signals transmitted by the network device 102 and rebroadcasting the signals to, for example, wireless client devices 105, which may out of range of the network device 102. The wireless extenders 103 can also receive signals from the wireless client devices 105, and rebroadcast the signals to the network device 102, or other wireless client devices 105.

The wireless client devices 105 can be, for example, hand-held computing devices, personal computers, electronic tablets, smart phones, smart speakers, IoT devices, iControl devices, portable music players with smart capabilities capable of connecting to the Internet, cellular networks, and interconnecting with other devices via Wi-Fi and Bluetooth, or other wireless hand-held consumer electronic devices capable of executing and displaying content received through the network device 102. Additionally, the wireless client devices 105 can be a TV, an IP/QAM STB or an SMD that is capable of decoding audio/video content and playing over over-the-top (OTT) or MSO provided content received through the network device 102.

The connection 109 between the network device 102 and the wireless extenders 103, AP 104, and wireless client devices 105, are implemented through a wireless connection that operates in accordance with, but is not limited to, any IEEE 802.11 protocols. Additionally, the connection 109 between the network device 102 and the wireless client devices 105 may also be implemented through a WAN, a local area network (LAN), a VPN, MANs, PANs, WLANs, SANs, a DOCSIS network, a fiber optics network (e.g., FTTH, FTTX, or HFC), a PSDN, a global Telex network, or a 2G, 3G, 4G or 5G network, for example.

Gateway 102, wireless extender 103, AP 104, and wireless client devices 105 may include an AP positioning application executed by a network controller to obtain positions values of client devices 105 relative to AP 104 within the network. The position values may be used to determine an optimum position for the AP 104.

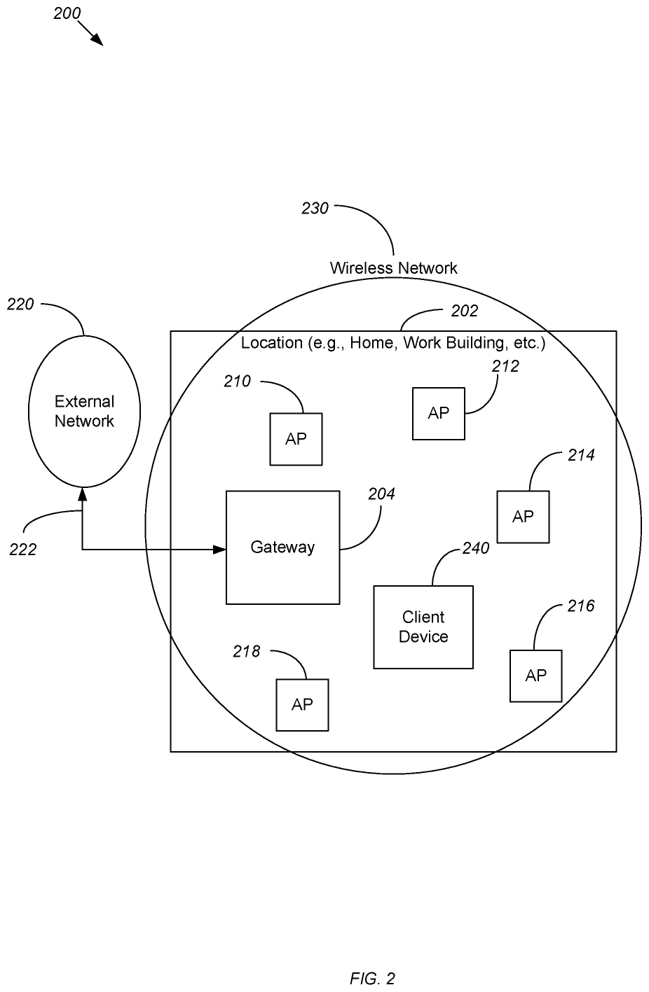

A detailed description of the exemplary internal components of the network device 102, the wireless extenders 103, AP 104, and the wireless client devices 105 shown in FIG. 1 will be provided in the discussion of FIGS. 2-4. However, in general, it is contemplated by the present disclosure that the network device 102, the wireless extenders 103, AP 104, and the wireless client devices 105 include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium.

Further, any, all, or some of the computing components in the network device 102, the wireless extenders 103, AP 104, and the wireless client devices 105 may be adapted to execute any operating system, including Linux, UNIX, Windows, MacOS, DOS, and ChromOS as well as virtual machines adapted to virtualize execution of a particular operating system, including customized and proprietary operating systems. The network device 102, the wireless extenders 103, AP 104, and the wireless client devices 105 are further equipped with components to facilitate communication with other computing devices over the one or more network connections to local and wide area networks, wireless and wired networks, public and private networks, and any other communication network enabling communication in the system.

FIG. 2 illustrates a wireless communication system 200.

In FIG. 2, wireless communication system 100 includes a location 202, a gateway 204, AP 210, AP 212, AP 214, AP 216, AP 218, a wireless client device 240, and external network 220. Location 202 may be any structure or home that contains each of gateway 204, AP 210, AP 212, AP 214, AP 216, AP 218, and wireless client device 240.

Gateway 204 may be any device or system that is operable to allow data to flow from a network including gateway 204, AP 210, AP 212, AP 214, AP 216, or AP 218 to external network 220 via communication channel 222, and to communicate by way of a Wi-Fi frequency band. Wireless network 230 is the network created by gateway 204, AP 210, AP 212, AP 214, Wi-Fi AP 216, Wi-Fi AP 218, and wireless client device 240.

In operation, an end-user will purchase and install each of gateway 204, AP 210, AP 212, AP 214, AP 216, and AP 218 in location 202. Once installed, the end-user will turn on the gateway 204 and each AP 210, 212, 214, 216, 218 in order to configure them for use in order to create wireless network 230 to provide wireless client device 240 access to external network 220. Once operating, gateway 204 will on-board each of AP 210, AP 212, AP 214, AP 216, and AP 218. The process of gateway 204 on-boarding an AP 210, 212, 214, 216, 218 is well known in the state of the art, and for purposes of brevity will not be further discussed here.

Once gateway 204 has on-boarded each of AP 210, AP 212, AP 214, AP 216, and AP 218, wireless network 230 is operational. At this time, wireless network 230 is able to begin operating on a spectrum of channels.

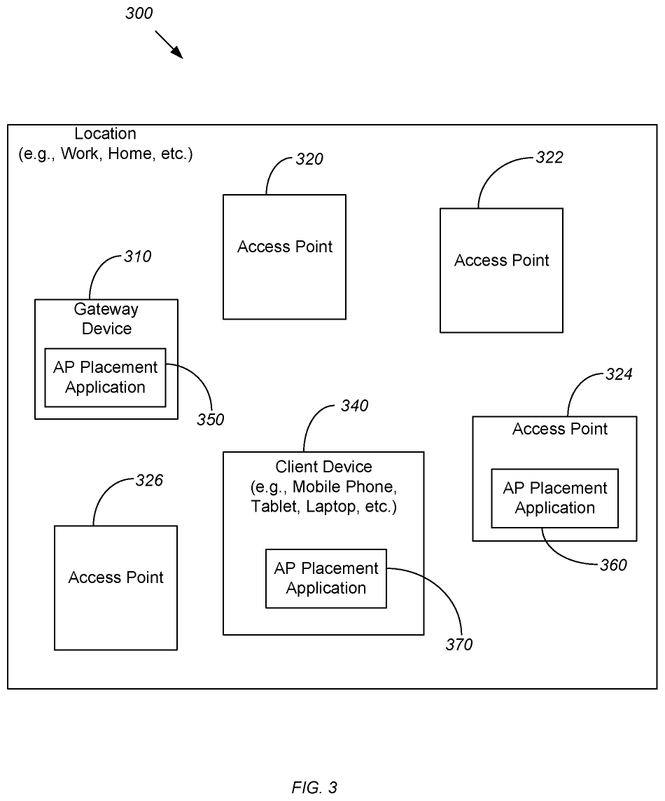

FIG. 3 illustrates wireless communication devices positioned in a location 300.

In comparison to FIG. 2, FIG. 3 shows more details of the communication devices situated the location 300. In FIG. 3, location 300 includes a gateway device 310, AP 320, 322, 324, 326, and client device 340. Gateway 310, AP 324, and client device 340 include AP placement applications 350, 360, 370, respectively. AP placement applications 350, 360, 370 may be configured to obtain positions values of client device 324 relative to an AP within the network, such as AP 324. The position values may be used to determine an optimum position for the AP 324 within location 300, wherein the optimum position for the AP may be based on a mean RSSI for all test points that is less than a signal quality threshold and a mean dwell time for all test points that is greater than a dwell time threshold.

For example, gateway device 310 may execute the AP placement application 350 to determine an initial signal quality measurements and coordinates for client device 340 relative to AP 324. The coordinates for the client device 340 may be actual or absolute physical coordinates, such as latitude and longitude. The coordinates for the client device 340 may also be relative coordinates that identify a position of the client device 340 with respect to the location of a known object, such as AP 324 or gateway 310. Coordinates may also refer to an abstract position, such as living room, kitchen, etc. Coordinates may further refer to a distance measurement to a nearby anchor nodes (nodes with known fixed positions, e.g., AP, and may be based on Bluetooth beacons, Wi-Fi beacons, ultra-wideband beacons, etc.

Wi-Fi positioning may be based on measuring the intensity of the received signal (received signal strength indicator (RSSI)) and “fingerprinting.” To increase the accuracy of fingerprinting methods, statistical post-processing techniques can be applied, to transform discrete set of “fingerprints” to a continuous distribution of RSSI of each access point over entire location. Typical parameters useful to geolocate a Wi-Fi hotspot or AP include SSID and MAC address of the AP. The accuracy depends on the number of positions that have been entered into the database. However, the possible signal fluctuations that may occur can increase errors and inaccuracies in the path of the user. Additional methods may include choke point concepts based on location indexing and presence reporting for tagged objects. Passive radio-frequency identification (RFID)/NFC systems do not report the signal strengths and various distances of single tags or of a bulk of tags and do not renew any before known location coordinates of the sensor or current location of any tags. Angle of arrival (AoA) and time of arrival (ToA) methods may also be used. Angle of arrival (AoA) is the angle from which a signal arrives at a receiver, such as client device 340. Time of arrival (ToA) is based on the amount of time a signal takes to propagate from a transmitter, such as from AP 324, to a receiver, such as client device 340. Because the signal propagation rate is constant and known (ignoring differences in mediums) the travel time of a signal can be used to directly calculate distance.

The signal quality measurements may include RSSI and dwell times for the client device 340 at different coordinates. The initial signal quality measurements and coordinates for client device 340 relative to AP 324 are provided to a machine learning classifier for initial training of the machine learning classifier. As client device 340 changes position within location 300, the gateway may collect signal quality measurements, such as RSSI and dwell times for the client device 340, at identified coordinates. The collected signal quality measurements and the coordinates of the client device 340 relative to the AP 324 are provided to the machine learning classifier. Test point data for the AP 324 are generated using the machine learning classifier. Based on the test point data associated with the AP, the gateway device 310 will decide whether a modification of the position of the AP 324 is required. The gateway device 310 will determine, from the test point data, coordinates for the modification of the position of the AP 324. The gateway device 310 decides a modification of the position of the AP 324 that is required based on a mean RSSI for all test points that is less than a signal quality threshold and based on a mean dwell time for all test points that is greater than a dwell time threshold.

The gateway device 310 determines initial signal quality measurements and coordinates relative to the AP by monitoring compass and accelerometer values, performing periodic signal quality measurements, storing the signal quality measurements and the coordinates relative to the AP, identifying dead zone coordinates relative to the AP based on the signal quality measurements, and repeating the monitoring, performing, storing and identifying for additional APs at the location. The gateway device 310 provides a notification and directional indicators to the client device to notify the client device 340 that it is about to enter dead zone and to indicate to the client device 340 movement in a direction for a better signal quality. For example, the notification and directional indicators may be a vibration by the client device 340. The vibration may increase in frequency or magnitude as the client device 340 moves in a direction with better signal quality and decrease in frequency or magnitude as the client device 340 moves in a direction with worse signal quality. Other notification and directional indicators may be visual or audible signals. The gateway device 310 provides the coordinates for the modification of the position of the AP 324 to the client device 340. While the above description has been based on the AP placement application 350 of the gateway device 310, the determination of an optimum position for an AP, such as AP 324, may be determined by AP placement application of AP 324 or by the AP placement application 370 of client device 340. Further, AP placement applications 350, 360, 370 may perform only some of the operations.

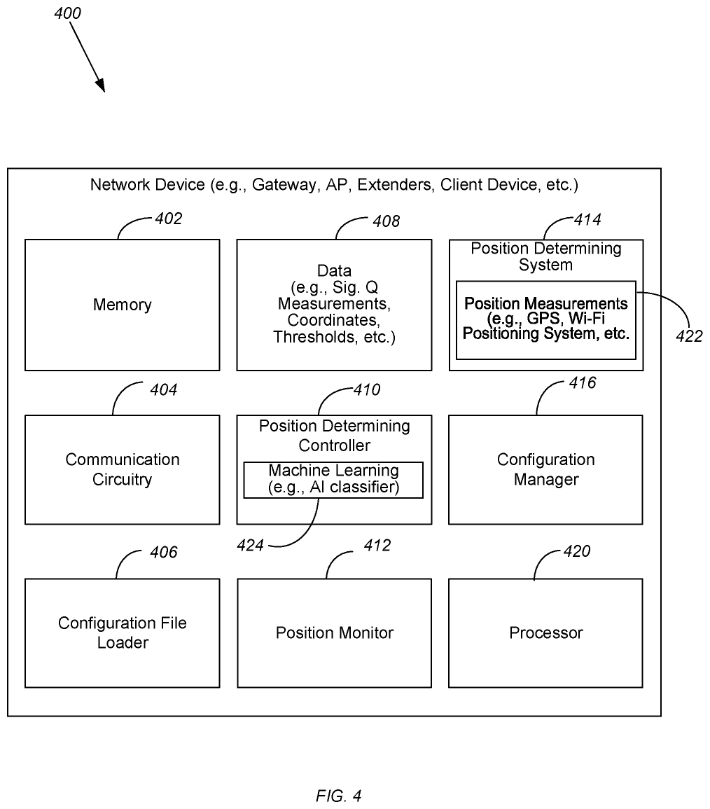

FIG. 4 illustrates a block diagram of a network device 400.

In FIG. 4, network device 400 includes memory 402, communication circuitry 404, configuration file loader 406, data 408, position determining controller 410, position monitor 412, position determining system 414, configuration manager 416, and processor 420. Data 408 may include values representing signal quality measurements, coordinates, thresholds, etc. Communication circuitry 404 transmits and receives of signals, such as Bluetooth signals, Wi-Fi signals and Ethernet signals that are analyzed by processor 420 to extract data 408. Configuration file loader 406 retrieves and installs configuration information, policy rules, etc. Monitor 412 examines one or more hardware devices via one or more local or remote networks, and generates health, performance, and utilization information about the network device 400. This information may be maintained as at least a part of data 408. Monitor may also maintain information about other network elements, such as APs, client devices, etc., which may also be maintained as at least a part of data 408. Configuration manager 416 supervises installation and operation of configuration files, such as an initial configuration file obtained by configuration file loader 406 to establish operation of the network device 400.

Position determining system 414 may include circuits that determine position measurements 422, such as GPS coordinates, Wi-Fi positioning system coordinates, etc. Postion determining controller 410 may be managed by processor 420 to implement artificial intelligence (AI) to provide machine learning 424, such as an AI classifier. Memory 402 will maintain instructions that are executed by processor 420 to implement functions of the network device 400. Position determining system 414 obtains positions measurements 422 of client devices relative to APs within the network. The position measurements 422 may analyzed by position determining controller 410 using machine learning to determine an optimum position coordinates of an AP within a location, wherein the optimum position coordinates for the AP may be based on a mean RSSI for all test points that is less than a signal quality threshold and a mean dwell time for all test points that is greater than a dwell time threshold. Position determining system 414 obtains position measurements 422, such as RSSI measurements, identified coordinates of client devices, thresholds, etc., and maintained by data 408.

Position determining controller 410 processes initial signal quality measurements and coordinates for a client device relative to an access point (AP). The initial signal quality measurements and client device coordinates are provided to a machine learning classifier 424 to initially train the machine learning classifier 424. Position determining controller 410 also receives position measurements 422, such as signal quality measurements and coordinates of the client device relative to the AP as the client device changes position within a location, e.g., a Wi-Fi cell or a contextual location such as kitchen, office, conference room, living room, etc. The position measurements 422, such as quality measurements and the coordinates of the client device relative to the AP, are provided to the machine learning 424 implemented by position determining controller 410. The machine learning 424 generates test point data for the AP, which may also be maintained at data 408. Based on the test point data associated with the AP, the position determining controller 410 decides a modification of the position of an AP is required. From the test point data, coordinates for the modification of the position of the AP are determined by position determining controller 410. Test point data maintained at data 408 may include coordinates of the client device relative to an AP, received signal strength indicators (RSSI) associated with each of the coordinates, and dwell times of the client device associated with each of the coordinates. Machine learning 424 processes the test point data to determine whether a modification of the position of the AP is required based on a mean RSSI for all test points is less than a signal quality threshold and a mean dwell time for all test points is greater than a dwell time threshold. A notification and movement indicator may be provided to the client device to inform the client device that it is headed to a dead zone. The coordinates for the modification of the position of the AP is provided by the position determining controller 410 to the client device via communication circuitry 404.

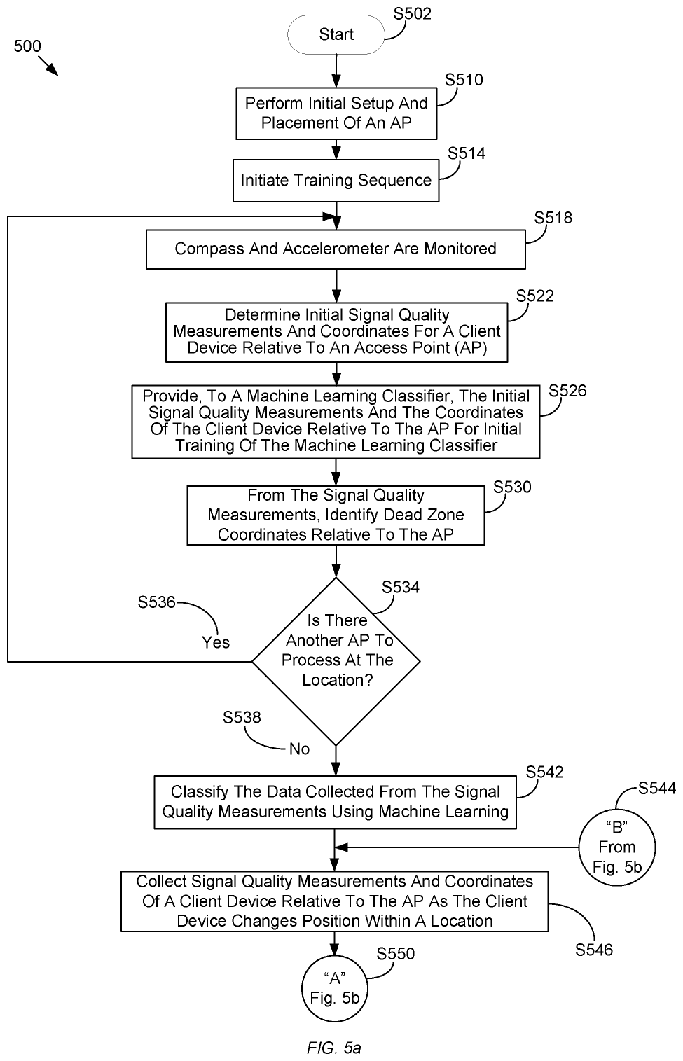

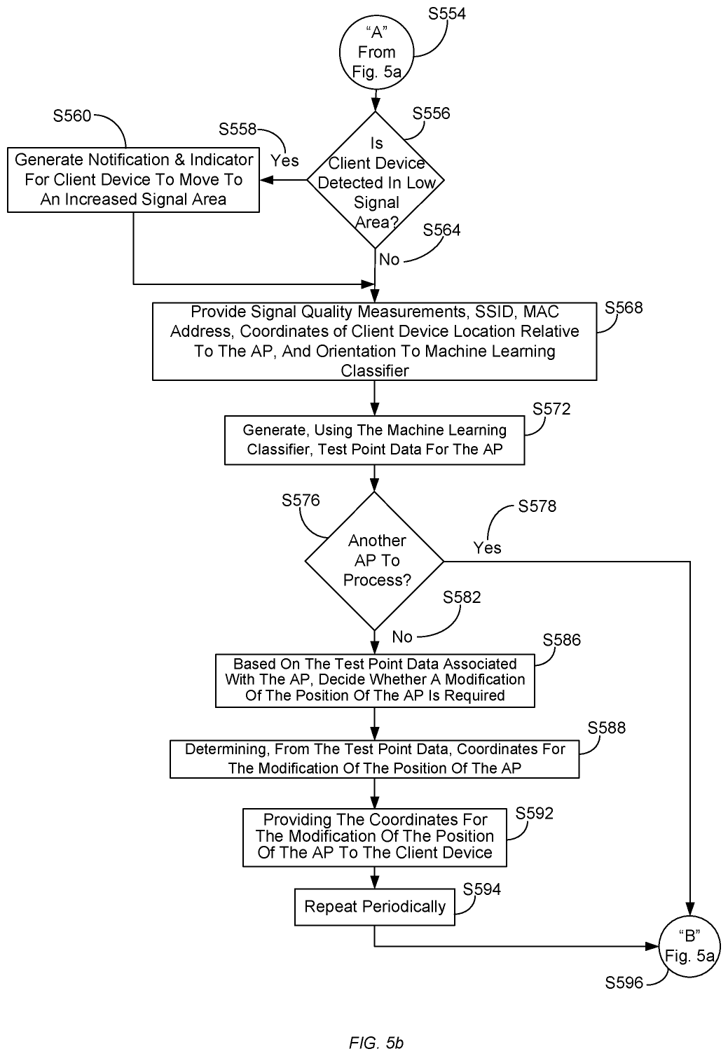

FIGS. 5a-5b illustrate a flow chart of a method 500 for using machine learning to develop client device test point and identify a new position for an access point (AP).

In FIG. 5a, method 500 starts (S502), and initial setup and placement of an AP is performed (S510). A training sequence is initiated (S514). The compass and accelerometer are monitored (S518). Initial signal quality measurements and coordinates for a client device relative to an access point (AP) are determined (S522). The initial signal quality measurements and the coordinates of the client device relative to the AP are provided to a machine learning classifier for initial training of the machine learning classifier (S526). From the signal quality measurements, dead zone coordinates relative to the AP are identified (S514). A determination is made whether there is another AP to process at the location (S534).

If there is another AP to process at the location (S536), the process loops back to monitor the compass and the accelerometer (S518). If there is not another AP to process at the location (S538), the data collected from the signal quality measurements is classified using machine learning (S542). Signal quality measurements and coordinates of a client device relative to the AP are collected as the client device changes position within a location (S546). The process then continues in FIG. 5b (S550).

FIG. 5b starts (S554). A determination is made whether a client device is detected in a low signal area, e.g., a dead zone (S556). If a client device is detected in a low signal area (S558), a notification and movement indicator for the client device to move to an increased signal area (S560). Signal quality measurements, service set identifier (SSID), MAC address, coordinates of a client device location relative to the AP, and orientation of the client device are provided to the machine learning classifier (S568). Test point data for the AP is generated using the machine learning classifier (S572). A determination is made whether there is another AP to process (S576).

If there is another AP to process (S578), the process loops back to collect signal quality measurements and coordinates of a client device relative to the AP as the client device changes position within a location (S546). If there not is another AP to process (S582), based on the test point data associated with the AP, a decision is made whether a modification of the position of the AP is required (S586). Coordinates for the modification of the position of the AP are determined from the test point data (S588). The coordinates for the modification of the position of the AP are provided to the client device (S592). The process repeats periodically (S596) and loops back to FIG. 5a collect signal quality measurements and coordinates of a client device relative to the AP as the client device changes position within a location (S546).

The processes discussed in this disclosure may be implemented in hardware, software, or a combination thereof In the context of software, the described operations represent computer-executable instructions stored on one or more computer-readable storage media that, when executed by one or more hardware processors, perform the recited operations. Generally, computer-executable instructions include routines, programs, objects, components, data structures, and the like that perform particular functions or implement particular abstract data types. Those having ordinary skill in the art will readily recognize that certain steps or operations illustrated in the figures above may be eliminated, combined, or performed in an alternate order. Any steps or operations may be performed serially or in parallel. Furthermore, the order in which the operations are described is not intended to be construed as a limitation.

The subject matter of the present disclosure may be provided as a computer program product including one or more non-transitory computer-readable storage media having stored thereon instructions (in compressed or uncompressed form) that may be used to program a computer (or other electronic device) to perform processes or methods described herein. The computer-readable storage media may include one or more of an electronic storage medium, a magnetic storage medium, an optical storage medium, a quantum storage medium, or the like. For example, the computer-readable storage media may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. Further, the subject matter of the present disclosure may also be provided as a computer program product including a transitory machine-readable signal (in compressed or uncompressed form). Examples of machine-readable signals, whether modulated using a carrier or unmodulated, include, but are not limited to, signals that a computer system or machine hosting or running a computer program may be configured to access, including signals transferred by one or more networks. For example, a transitory machine-readable signal may comprise transmission of software by the Internet.

Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as exemplary forms of implementing the claims.

What is claimed is:

1. A network device, comprising:
a memory storing computer-readable instructions; and
a processor configured to execute the computer-readable instructions to:
determine initial signal quality measurements and coordinates for a client device relative to an access point (AP);
provide, to a machine learning classifier, the initial signal quality measurements and the coordinates of the client device relative to the AP for initial training of the machine learning classifier;
collect signal quality measurements and coordinates of the client device relative to the AP as the client device changes position within a location;
provide the collected signal quality measurements and the coordinates of the client device relative to the AP to the machine learning classifier generate, using the machine learning classifier, test point data for the AP;
based on the test point data associated with the AP, decide a modification of a position of the AP is required; and
determine, from the test point data, coordinates for the modification of the position of the AP.

2. The network device of claim 1, wherein the processor generates test point data using coordinates of the client device relative to an AP, received signal strength indicators (RSSI) associated with each of the coordinates, and dwell times of the client device associated with each of the coordinates.

3. The network device of claim 2, wherein the processor decides the modification of the position of the AP is required based on a mean RSSI for all test points is less than a signal quality threshold and a mean dwell time for all test points is greater than a dwell time threshold.

4. The network device of claim 1, wherein the processor determines initial signal quality measurements and coordinates relative to the AP by further:
monitoring compass and accelerometer values;
performing periodic signal quality measurements;
storing the signal quality measurements and the coordinates relative to the AP;
identifying dead zone coordinates relative to the AP based on the signal quality measurements; and
repeating the monitoring, performing, storing and identifying for additional APs at the location.

5. The network device of claim 4 wherein the processor provides a notification to the client device indicating the client device is positioned in a dead zone.

6. The network device of claim 1, wherein the processor collects signal quality measurements by measuring received signal strength indicators (RSSI).

7. The network device of claim 1, wherein the processor provides the coordinates for the modification of the position of the AP to the client device.

8. A method for providing enhanced Wi-Fi coverage in a location, comprising:
determining initial signal quality measurements and coordinates for a client device relative to an access point (AP);
providing, to a machine learning classifier, the initial signal quality measurements and the coordinates of the client device relative to the AP for initial training of the machine learning classifier;
collecting signal quality measurements and coordinates of the client device relative to the AP as the client device changes position within the location;
providing the collected signal quality measurements and the coordinates of the client device relative to the AP to the machine learning classifier
generating, using the machine learning classifier, test point data for the AP;
based on the test point data associated with the AP, deciding a modification of a position of the AP is required; and
determining, from the test point data, coordinates for the modification of the position of the AP.

9. The method of claim 8, wherein the generating test point data further comprises processing coordinates of the client device relative to an AP, received signal strength indicators (RSSI) associated with each of the coordinates, and a dwell times of the client device associated with each of the coordinates.

10. The method of claim 9, wherein the deciding the modification of the position of the AP is required further comprises determining a mean RSSI for all test points is less than a signal quality threshold and determining a mean dwell time for all test points is greater than a dwell time threshold.

11. The method of claim 8, wherein the determining the initial signal quality measurements and the coordinates relative to the AP further comprises:
monitoring compass and accelerometer values;
performing periodic signal quality measurements;
storing the signal quality measurements and the coordinates relative to the AP;
identifying dead zone coordinates relative to the AP based on the signal quality measurements; and
repeating the monitoring, performing, storing and identifying for additional APs at the location.

12. The method of claim 8 further comprises provides a notification to the client device indicating the client device is positioned in a dead zone.

13. The method of claim 8, wherein the collecting signal quality measurements further comprises measuring received signal strength indicators (RSSI).

14. The method of claim 8 further comprises providing the coordinates for the modification of the position of the AP to the client device.

15. A non-transitory, computer-readable media having computer-readable instructions stored thereon, the computer-readable instructions being capable of being read by a network device, wherein the computer-readable instructions are capable of instructing the network device to provide enhanced Wi-Fi coverage in a location, comprising:
determining initial signal quality measurements and coordinates for a client device relative to an access point (AP);
providing, to a machine learning classifier, the initial signal quality measurements and the coordinates of the client device relative to the AP for initial training of the machine learning classifier;
collecting signal quality measurements and coordinates of the client device relative to the AP as the client device changes position within the location;
providing the collected signal quality measurements and the coordinates of the client device relative to the AP to the machine learning classifier
generating, using the machine learning classifier, test point data for the AP;
based on the test point data associated with the AP, deciding a modification of a position of the AP is required; and
determining, from the test point data, coordinates for the modification of the position of the AP.

16. The non-transitory, computer-readable media of claim 15, wherein the generating test point data further comprises processing coordinates of the client device relative to an AP, received signal strength indicators (RSSI) associated with each of the coordinates, and a dwell times of the client device associated with each of the coordinates.

17. The non-transitory, computer-readable media of claim 16, wherein the deciding the modification of the position of the AP is required further comprises determining a mean RSSI for all test points is less than a signal quality threshold and determining a mean dwell time for all test points is greater than a dwell time threshold.

18. The non-transitory, computer-readable media of claim 15 further comprises provides a notification to the client device indicating the client device is positioned in a dead zone.

19. The non-transitory, computer-readable media of claim 15, wherein the collecting signal quality measurements further comprises measuring received signal strength indicators (RSSI).

20. The non-transitory, computer-readable media of claim 15 further comprises providing the coordinates for the modification of the position of the AP to the client device.
